(19) United States
(12) Patent Application Publication
(10) Pub. No.: US 2022/0092153 A1
(43) Pub. Date: Mar. 24, 2022

(54) SYSTEM AND METHOD FOR SECURING STORED AND MERGED IMAGES USING BLOCKCHAIN

(71) Applicants: Robert Cantrell, Herndon, VA (US); Chris Harder, Rocklin, CA (US)

(72) Inventors: Robert Cantrell, Herndon, VA (US); Chris Harder, Rocklin, CA (US)

(21) Appl. No.: 17/482,266

(22) Filed: Sep. 22, 2021

Related U.S. Application Data
(60) Provisional application No. 63/124,642, filed on Dec. 11, 2020.
(60) Provisional application No. 63/082,962, filed on Sep. 24, 2020.

(51) Int. Cl. G06F 21/10; H04L 9/32; G06N 3/063; G06F 16/27

(52) U.S. Cl. CPC G06F 21/10; H04L 9/3236; G06F 2221/0724; G06F 16/27; H04L 2209/38; G06N 3/063

(57) ABSTRACT

A distributed blockchain system and method for storing, securing, and retrieving digital content, the system and method having a plurality of nodes designed to communicate over a network having one or more network devices. A control circuit assembly receives and transmits information via the network. A neural processing unit merges and unmerges digital content, the merged content viewable on at least one or more user interface and the unmerged content conditionally viewable from the merged content on the at least one or more user interface by way of one or more encrypted private keys. A computer-readable storage memory assembly, wherein the computer-readable storage memory assembly comprises a volatile memory storing a set of one or more computer-readable interactions, which when executed by the control circuit assembly cause the plurality of nodes to update the blockchain stored in a memory assembly based on communication with other nodes over the network assembly.

### CROSS REFERENCE TO RELATED APPLICATIONS

This application claims the benefit of U.S. Provisional Application No. 63/124,642 filed on Dec. 11, 2020, and U.S. Provisional Application No. 63/082,962 filed on Sep. 24, 2020, which are incorporated herein by reference in their entireties. The following patents are incorporated by reference in their entireties: U.S. Pat. Nos. 8,234,387, 6,449,377, KR102078968B1, WO2018222846A1, US20160203572A1, US20170243179A1, US20180294957A1, and US20160259404A1.

### FIELD OF THE INVENTION

Inventive concepts relate generally to merging, storing, and securing digital images using blockchain.

### BACKGROUND

It is easy to make identical copies of unprotected digital works. Digital works can also be copied with some loss of quality when on display because a person can photograph a displayed document, screen-capture it, or otherwise duplicate the image in a form good enough for at least some users, even if the copy is of a lower quality than the original. As tools for accessing and stealing digital works become more sophisticated, tools to prevent or discourage theft of digital works either by blocking theft or helping enforcers track the thieves becomes more important, all the more so if owners wish to limit the number of copies made from a digital work. An improved system for recording ownership of digital works, and providing backup copies that are otherwise not distributed, is needed for users who have purchased digital works.

### SUMMARY OF THE INVENTION

Described in detail herein is a system and method for creating, managing, and securing digital content, notably but not exclusively digital art, and recording ownership of digital works. More specifically, described herein is a computer-implemented system and method for storing, securing, and retrieving digital content created by the disclosed system, wherein securing is accomplished via blockchain and the merging of digital works—the digital works at least partially obscured, therefore—users with an encrypted key able to unlock the associated digital works. In various embodiments, described herein, is a computer-implemented system and method of merging digital content. The blockchain system can be used to track a single unit of a digital work, such as a photograph, a digitally created or rendered artwork, the output of a digital sketchpad, the output of a digital paint brush or other digital coloring tools, letters, music, private written records, manuscripts, notebooks, letters, videos, computer code, and 3D printing templates. For example, if a user purchases a digital artwork, the digital artwork is given a blockchain code unique to that copy. Every time that copy of the digital artwork is transferred, the digital artwork can receive a new blockchain code and a new block can be generated. Therefore, the blockchain system can trace to the source of origin copies made within the associated blockchain system. The blockchain system may also indicate that a copy is illegitimate and prevent the transfer of the digital artwork. The blockchain ensures the integrity of the digital artwork as one, singular unit and secures the content therein.

Exemplary embodiments of the blockchain system can also provide a way for users to sell digital artwork in substantially the same way users sell physical works such as paintings or photographs, providing a unique blockchain code to a copy of digital artwork created using the disclosed system. The coding may include a mechanism whereby digital artwork can be sold, resold, or a new copy generated by users and transferred from their account, perhaps with a royalty being paid to the owner or creator of the digital artwork. Some coding may be added when triggered by a blockchain action such as a royalty payment. Exemplary embodiments of the disclosed blockchain system can allow a digital artwork to be created as a single unit or as a derivative digital artwork by combining several other digital works. The digital artwork can be tracked, transferred singly, monitored, and duplicated with proper permissions. If the digital artwork is duplicated with proper permissions, a new digital record can be created or mined that is traceable to its source but otherwise gets its own blockchain string. The digital blockchain can be traceable back to its single, common ancestor, even if the digital artwork for which the blockchain is created evolves.

In another example, the disclosed blockchain system can be used for creating a digital artwork and other digital works or records that include confirming information as needed about the time of origin, location of origin, and integrity of the creation if this information is important for confirming who created the digital artwork along with other elements, as needed, about what, where, when, how, and why the digital artwork was created. The blockchain system can further confirm that the digital artwork at that point must not evolve, for example, change without creating a new timestamp and record fingerprint. One or more algorithms can be added to a digital artwork that indicate the potential for the integrity of digital artwork to be compromised such as by digital copying to personal drives, modification without permissions, or even scroll-and-stop patterns that could indicate someone is photographing or screen-capturing content off a computer display. When such activity is detected, the digital artwork may automatically close, pending verification of legitimate use.

In various embodiments, a method of assessing the digital artwork is disclosed, wherein to access digital artwork, a user may be required to exchange at least one hashtag key so that the holder of a digital artwork exchanges the right or value to view and handle the digital artwork with a requester given the permission to see the digital artwork. So even if a digital artwork was spirited outside a firewall of the owner or creator of the digital artwork, as one example, the digital artwork cannot be accessed without the proper hashtag keys. In many embodiments, an act by the user or a third party involving the digital artwork created using the disclosed system may automatically change the hashtag key, including creating a derivative work, a change transparent to those with legitimate access but locking out illegitimate access. A legitimate user or owner of the digital artwork can receive the updated hashtag key instantly, but the illegitimate user, even if possessing the current hashtag key, would be locked out without receiving the updated key. Further, the hashtag key could, in one embodiment, reside in a device that is physically separated from a repository such that the physical device must be mechanically or electrically connected to the repository to work, countering remote hacking and making it easier to detect insider hacking. Using the disclosed security provisions, the system may further emulate, for digital artwork, the privacy, physicality, and security of physical artwork.

The creator or owner of a digital artwork, for example, a graphic artist or a photographer, could change the settings on his or her digital artwork to allow sharing or incorporation of the digital artwork into derivative digital artwork such as by coupling or merging the digital artwork with one or more other digital artworks or with other digital items while still retaining the legal copyright by existing or modified copyright terms. Depending on the content, adding to the blockchain could be automatic, such as in response to the creation of a merged (derivative) digital artwork, or adding to the blockchain could happen on demand upon the creation or modification of the digital work such as to a digital artwork that may come from other copyrighted or non-copyrighted sources but that, through a derivative digital artwork, a unique digital artwork is created that the creator does not want shared without granting permission or being compensated.

In various embodiments, the disclosed blockchain system can be used for digital artwork on its original or derivative form whereby the digital artwork at that point must not evolve, for example, change without creating a new timestamp and record fingerprint. Blockchain events could be triggered each time the specific digital artwork is accessed, copied, added to, viewed, read, and so on. This addition could be done to a granular level, and algorithms can be added that indicate the potential for violations of intellectual property protection, such as digital copying to personal drives, plagiarism by cut-and-paste or type copying, or even scroll-and-stop patterns that could indicate someone is photographing content off a computer screen. When such activity is detected, the digital artwork can be automatically closed pending verification of legitimate use, or a warning may be posted, or the digital artwork otherwise may be digitally watermarked to diminish the quality and usability of the copied digital artwork. A digital artwork more generally is an item of digital content.

In one embodiment, the present disclosure provides a computer-implemented system and method for storing, securing, and retrieving digital content comprising receiving a first plurality of data from one or more computer assemblies wherein the first plurality of data includes one or more first digital images and receiving at least one second plurality of data from the one or more computer assemblies wherein the second plurality of data includes at least one second digital image. The first plurality of data from the one or more computer assemblies is registered, calibrated, and coordinated so the one or more first digital images at least partly overlap. The registered, calibrated, and coordinated first plurality of data is sent to a neural processing unit (NPU) assembly, the NPU assembly designed to at least partially blend the first plurality of data so as to include one or more first combined digital images. The first plurality of data that includes the one or more first combined digital images from the one or more computer assemblies and the second plurality of data from the one or more computer assemblies is registered, calibrated, and coordinated to create a second registered, calibrated, and coordinated data assembly so the one or more first combined digital images and at least one second digital image at least partly overlap. The at least one second registered, calibrated, and coordinated data assembly is sent to the NPU assembly on at least one computer assembly configured with the NPU assembly or a software able to perform neural processing on one or more computer processing units (CPUs), wherein the NPU assembly is designed to at least partially blend the first plurality of data from the one or more computer assemblies that include the one or more first combined images and the second plurality of data from the one or more computer assemblies so as to include one or more second combined digital images. The production of the one or more second combined digital images triggers communicating with one or more nodes in a computer network assembly to validate the production of the one or more second combined digital images and assigns one or more encrypted private keys thereto.

A neural processor or NPU is a specialized circuit that implements all the necessary control and arithmetic logic necessary to execute machine learning algorithms, typically by operating on predictive models such as artificial neural networks (ANNs) or random forests (RFs). NPUs sometimes go by similar names such as a tensor processing unit (TPU), neural network processor (NNP), and intelligence processing unit (IPU) as well as vision processing unit (VPU) and graphic processing unit (GPU). An NPU may be emulated on one or more CPUs by a software solution.

In one embodiment, the computer-implemented system and method for storing, securing, and retrieving digital content further comprises, a third plurality of data from one or more computer assemblies wherein the third plurality of data is registered, calibrated, and coordinated to at least partly overlap the one or more second combined digital images. The registered, calibrated, and coordinated third plurality of data is then sent to the NPU assembly, wherein the NPU assembly is designed to at least partially blend the registered, calibrated, and coordinated third plurality of data into the one or more second combined digital images.

In one embodiment, the computer-implemented system and method for storing, securing, and retrieving digital content further comprises, the first plurality of data from the one or more computer assemblies and the at least one second plurality of data from the one or more computer assemblies, wherein the first plurality of data and the second plurality of data is stored both in registered, calibrated, and coordinated form and in unregistered, uncalibrated, and uncoordinated form. In various embodiments, the computer-implemented system and method for storing, securing, and retrieving digital content further comprises storing the unregistered, uncalibrated, and uncoordinated data within the at least one second registered, calibrated, and coordinated data assembly. In another embodiment of the computer-implemented system and method for storing, securing, and retrieving digital content, the unregistered, uncalibrated, and uncoordinated data is designed to be stored in a separate file on the same or on one or more different data storage apparatuses.

In one embodiment, a computer-implemented system and method storing, securing, and retrieving digital content is disclosed comprising at least one fourth plurality of data received from the one or more computer assemblies associated with a first user wherein the one fourth plurality of data includes one or more image, audio, video, or text content assemblies, the fourth plurality of data designed to be combined with the second registered, calibrated, and coordinated data assembly. This fourth plurality of data may be combined or coupled with the first plurality of data, the second plurality of data, or both but is not registered, calibrated, or coordinated for merging.

In one embodiment, the present disclosure relates to a computer-implemented system and method storing, securing, and retrieving digital content, wherein the method involves receiving at least one machine-readable code assembly containing coded information corresponding to a first plurality of data from the one or more computer assemblies, wherein the first plurality of data includes one or more first digital images, and corresponding to at least one second plurality of data from the one or more computer assemblies, wherein the at least one second plurality of data includes at least one second digital image. A user scans the machine-readable code assembly with a scanner assembly in communication with at least one computing system configured with a machine-readable code processing assembly. The method further comprises processing the machine-readable code assembly to retrieve the coded information therein and processing the coded information therein to retrieve from the first plurality of data and the at least one second plurality of data, wherein a data assembly is formed of the first plurality of data and the at least one second plurality of data in an uncombined state. One of ordinary skill in the art would recognize that data in the uncombined state could be viewed or otherwise employed in its original form, for example, a viewed jpeg or tiff image.

Machine-readable data is data in a format that can be easily processed by a computer without human intervention while ensuring no semantic meaning is lost. Machine-readable data may be classified in two groups: human-readable data that is marked up so that it can also be read by machines (e.g. microformats, RDFa, HTML), and data file formats intended principally for processing by machines.

In one embodiment of the computer-implemented system and method storing, securing, and retrieving digital content, the first plurality of data and the at least one second plurality of data in an uncombined state is stored within the one or more second combined digital images.

In one embodiment of the computer-implemented system and method storing, securing, and retrieving digital content, the first plurality of data and the at least one second plurality of data in an uncombined state is stored on at least one separate file on at least one data storage apparatus such as a computer drive assembly. One of ordinary skill in the art would recognized that the data in the uncombined state would be indexed to the data in the combined state, wherein the holder of the data in the combined state could locate the data in the uncombined state.

In one embodiment of the computer-implemented system and method for storing, securing, and retrieving digital content, the user can sort through images, the user can preview the one or more images in high-resolution, the one or more images can have words written on them much like photo stamps or photo stickers, and the person can share each of the one or more images by email, text, social media links, or other digital content transmission. One or more videos may pop out on a screen. The user can click on or otherwise activate the one or more videos to watch the one or more videos. The one or more videos are substantially links configured to allow the one or more videos to be played. One or more audio files may be accessible on screen. When the one or more audio files are clicked on or otherwise activated, the one or more audio files play. Further, one or more document files may pop out on screen. The one or more document files can be clicked on or otherwise activated and reviewed on screen.

In one embodiment of the computer-implemented system and method for storing, securing, and retrieving digital content, the digital content is termed a heart. A heart is a digital artwork and may also be used as a repository for data used to derive the digital artwork or may be used as a repository for data though that data is not used to derive the digital artwork. A heart may be a digital artwork apart from other digital content or other digital artworks and may stand on its own or may be incorporated or have incorporated into it other digital artworks or other digital content and still be termed a heart. The NPU may be designed to produce an artwork such as a heart and to apply machine learning to produce derived works under at least one or more of selected criterion such as to be substantially heart shaped and be aesthetically pleasing to the user.

The term high-resolution is a relative term and is used to describe any element of an embodiment. Compared to a low-resolution image, a high-resolution image has more pixels, lower compression, or both. One of ordinary skill in the art would recognize that high-resolution is a relative term and may differ from person to person and generally refers to a viewed image that may have more pixels, lower compression, or both than one or more preview images.

One embodiment of the computer-implemented system and method storing, securing, and retrieving digital content comprises use of a TRON blockchain protocol which distributes computing resources equally among TRON (TRX) holders with internal recourse control mechanisms such as bandwidth and energy. One of ordinary skill in the art would recognize that TRON provides a decentralized virtual machine which can execute a program using an international network of public nodes. TRON may define a proof-of-stake architecture, a type of consensus algorithm by which a blockchain network aims to achieve distributed consensus. One of ordinary skill in the art would recognize that inventive concepts may use other blockchain protocols known to those of ordinary skill in the art such as, but not limited to, Ethereum, Neo, Bitshares, or Waves and Qtum, and that inventive concepts are designed to be configurable to new blockchain protocols.

In one embodiment, the computer-implemented system and method for merging digital content further comprises, a virtual reality for a viewer to view digital artwork. In another embodiment, an augmented reality assembly serves as the virtual reality assembly. The augmented reality assembly blends what the user sees in real surroundings with digital content generated by a computer assembly. The additional software-generated images with the virtual scene enhance how the real surroundings look by displaying the virtual artwork. The augmented reality assembly layers virtual information over a camera feed assembly and into a headset assembly, a smart glasses assembly, or a portable handheld device assembly, giving the user the ability to view two- and three-dimensional images, including images that may change appearances over time.

In one embodiment, the computer-implemented system and method storing, securing, and retrieving digital content uses a mixed reality assembly. The mixed reality assembly merges the real world and virtual worlds to produce new environments and visualizations where physical and digital objects co-exist and interact in real time. One of ordinary skill in the art would recognize that any means for displaying digital artwork may be used within inventive concepts as long as the means for displaying the digital artwork can open and display the associated digital artwork and other associated digital content.

In one embodiment of the computer-implemented system and method for storing, securing, and retrieving digital content, a user can view and sort through one or more images. The images may have words or other information disposed on or within them and the user can share each of the images to other people via email, social media links, portals, Websites, or other communications assemblies. In one embodiment using augmented reality, the one or more images may pop out as small thumbnails in a hovering grid pattern. The user, in this exemplary embodiment, can walk over the image grid and select an image. The image in this exemplary embodiment will appear in a substantially larger size. Users may save the image and share the image. Users can shrink the image back down and will be able to sort or view the other images.

In one embodiment of the computer-implemented system and method for storing, securing, and retrieving digital content, the disclosed system and methods may use one or more video files appearing on screen or in a projected form. The videos in this exemplary embodiment are links allowing the videos to be played and can be shared and may be embedded by users accessing the video. In another embodiment, the disclosed system and methods may use augmented reality, wherein a thumbnail image of the video will pop out of the heart and onto a surface. In this exemplary embodiment, the user will approach the video in the augmented reality and click or otherwise activate the video to watch it. The video can be seen in full screen on the phone, or the video may play hovering in space within the view space of the augmented reality.

In one embodiment of the computer-implemented system and method for storing, securing, and retrieving digital content, the disclosed system and method may use one or more audio files accessible on screen or otherwise accessible to the user. In another embodiment, the disclosed system and method may further comprise of at least one icon wherein the icons may be clicked, leading to the files playing on a digital playback device which may be a computer device. In one embodiment using augmented reality, the one or more audio files play an animation viewable on screen or projected on a surface. The user may approach the audio file and click or otherwise activate the file playback to allow the audio files to be heard.

In one embodiment of the computer-implemented system and method for storing, securing, and retrieving digital content, the disclosed system and methods may use one or more document files accessible on screen or otherwise accessible to the user. The one or more documents may be clicked or otherwise activated and reviewed on screen.

In one embodiment of the computer-implemented system and method for storing, securing, and retrieving digital content, a user or a customer creates at least one full heart—complete file of combined and possibly registered, calibrated, and coordinated files—that contains images, videos, audio files, and docs, and will have at least the following options available such as creating the at least one heart involving a landing page where empty hearts are purchased and then filled with digital content. If the user wants to create another heart, then the user will go to a purchase section to buy the heart and to fill the heart with the digital content they want to add to the heart. In various embodiments, owning a heart may involve taking the user to a page that will allow the user to buy the image of his or her created heart on one or more different types of products. In various embodiments, selling a heart may involve selling the heart if the user filled the heart with blockchain-protected content as a heart token. Once the heart token is in a digital wallet, the person will be able to market the digital art. Sharing a heart in this embodiment may involve, if the person has an augmented-reality enabled smartphone, the person downloading an application to experience the heart in augmented reality. Once the heart is scanned, the content inside the heart becomes accessible, allowing the person to watch, listen, and read the content in the heart file uploaded or saved inside by the heart's creator. Selecting a favorite heart may involve allowing a user to post a story to talk about why that user created the heart as might be done to help promote a cause or a charity. Developing a heart may involve having someone sign up to be a part of a mailing list, or if someone buys an empty heart, this section unlocks and allows the person to send as many future emails as desired.

In one embodiment of the disclosed system and method, a user is the owner of a heart, or the user has the heart in his or her digital wallet, the user may be able to print the heart on many different print-on-demand items. For example, if the user wants to print the heart on a tee-shirt, an exemplary process follows: The owner of the heart will click on the heart to go to a webpage corresponding to the heart that shows the content inside the heart. The owner of the heart clicks on a purchase products button on the Webpage. The link will take the owner to another Webpage that will allow the owner to browse and search for products on which to get the heart printed. When the owner of the heart finds a product option, the owner clicks on the product option and the image of the heart gets attached to the shirt. After selecting the size, color, and entering the shipping address, the owner clicks on a purchase button after which the shirt is printed.

In one embodiment, a user buys a custom-made augmented reality simulation on top of the heart he or she created. Whenever the user's heart is scanned using an associated augmented reality camera, an augmented reality layer plays on top of the heart to make the heart appear as if alive or otherwise animated. If the user wants to add an artistic touch to the heart, the user may enhance the experience to have a unique augmented reality experience added to their heart art. In one embodiment, the user may place real cryptocurrency and/or nonfungible tokens (NFTs) inside the heart. When the user unlocks the heart, the user receives or has access to the contents inside the heart.

In one embodiment, the present disclosure relates to a computer-implemented system and method for securing digital content comprising generating a cryptographically verifiable ledger represented by a sequence of blocks, each block containing one or more ownership records and each subsequent block containing a hash value associated with the previous block, wherein at least one of the blocks contains ownership records associated with ownership of a digital artwork, and wherein the at least one of the blocks that contains ownership records associated with ownership of the digital artwork includes restrictions associated with transfers of the digital artwork. In various embodiments, the present disclosure further comprises a storage system and method, wherein the storage system receives a first request from at least one user terminal device to obtain the digital artwork. The storage system determines whether the restrictions associated with the use of the digital artwork prevents satisfying the request and permits the request for the digital artwork in response to determining the request is authorized. In one embodiment, the request is to merge the digital artwork with one or more second digital works to create a derived digital artwork. In another embodiment, the request is to add one or more second digital works to the digital artwork, wherein the one or more second digital works is not merged to create a derived digital artwork. One of ordinary skill in the art would recognize that many other types of requests may be made.

One embodiment disclosed herein comprises a distributed blockchain system for storing, securing, and retrieving digital content, wherein a plurality of nodes communicates over a network assembly. A network interface assembly comprises one or more network devices. A control circuit assembly is included to receive and transmit information via the network assembly. A computer-readable storage memory assembly is included, wherein the computer-readable storage memory assembly comprises a volatile memory storing a set of one or more computer-readable interactions, which when executed by the control circuit assembly, cause the plurality of nodes to update the blockchain stored in a memory assembly based on communication with other nodes over the network assembly. The plurality of nodes in the distributed blockchain system for storing, securing, and retrieving digital content may have a distributed blockchain server assembly. The system comprising at least one node may further comprise 1) a network interface assembly, 2) a control circuit assembly, and 3) a memory assembly wherein the node communicates over a network assembly updating the blockchain stored in the memory assembly based on communications with at least a second node.

With the system and processes shown herein, once a block is formed for the digital artwork, the block cannot be changed without redoing the work to satisfy census rules, thereby securing the block from tampering or change. A digital artwork may be fixed as a creation in space, in time, by the material aspect of the data making up the digital artwork to give the artwork its appearance to one or more human and/or artificial senses. An unapproved accessor would need to provide proof standard for each block subsequent to the one he or she seeks to modify, outpace all other nodes, and overtake the majority of the system to affect change to an earlier record in the blockchain.

The blockchain system used for digital artwork can use a peer-to-peer distributed timestamp server to generate computational proof of the chronological order of transactions. Generally, the blockchain system is secure as long as honest or neutral nodes collectively control more processing power than any cooperating group of malicious nodes. With a blockchain, the transaction records are computationally impractical to reverse. As such, owners of digital artworks are protected from fraud.

In some embodiments, in the peer-to-peer network, the longest chain proves the sequence of events witnessed, proves that the sequence came from the largest pool of processing power, and that the integrity of the digital artwork has been maintained. In some embodiments, the network for supporting blockchain-based record keeping requires minimal structure. In some embodiments, messages for updating the record are broadcast on a best-effort basis. Nodes can leave and rejoin the network at will and may be configured to accept the longest proof-of-work chain as proof of what happened while users were away.

In some embodiments of the disclosed system and methods, the blockchain system may be used to ensure that a digital artwork was not altered after a given timestamp, that alterations made or derivative work made from the digital artwork can be followed to a traceable point of origin, that only people with authorized keys can access the digital artwork, that the digital artwork itself is the original digital artwork and cannot be duplicated, that where duplication is allowed and the integrity of the copy or derivative work is maintained along with the original, that the creator of the copy or derivative digital artwork was authorized to create the digital artwork and associated files that may be merged or coupled with the digital artwork, and/or that the holder of the digital artwork was authorized to transfer, alter, or otherwise act on the digital artwork and associated files.

Blockchain is a digital database containing information (such as records of financial transactions) that can be simultaneously used and shared within a large, decentralized, publicly accessible network. As used herein, in some embodiments, the term blockchain may refer to one or more of a hash chain, a hash tree, a distributed database, and a distributed ledger that could present a cryptographically verifiable ledger. In some embodiments, blockchain may further refer to systems that use one or more of cryptography, private/public key encryption, proof standard, distributed timestamp server, and inventive schemes to regulate how new blocks may be added to the chain.

Descriptions of embodiments of blockchain technology are provided herein as illustrations and examples only. The concepts of the blockchain system may be variously modified and designed for different applications.

Inventive concepts utilizes a peer-to-peer authentication system for valuable digitized items such as, for example: 1) digital cash; 2) intellectual property; 3) private financial data; 4) chain of title to one or more rights; 5) real property; 6) digital wallet; 7) digital representation of rights including, such as, for example, a license to intellectual property; 8) digital representation of a contractual relationship; 9) medical records; 10) security clearance rights; 11) background check information; 12) passwords; 13) access control information for physical or virtual space; 14) digital artwork or unique derivatives of digital artwork; 15) digital images; 16) digital video or audio; and 17) combinations, variations, and permutations of one or more of the foregoing that allows online interactions directly between two or more parties without going through one or more trusted intermediaries. A peer-to-peer network timestamps actions include, for example: 1) document transfer, 2) document access, 3) document change, 4) document copying, 5) document merging, or 6) other activities through which the digital content is used for 1) its content as an item for trade, 2) its content as a record to be verifiably maintained or changed, or 3) as an item for remuneration, hashing them into an ongoing chain of hash-based proof-of-work code to form a record that cannot be changed without redoing the proof-of-work. The longest chain distributed on the peer-to-peer network proves that the data must have existed at the time in order to get into the hash, thereby proving the sequence of events witnessed, thereby further proving that the integrity of the digitized document has been maintained. A new block is added, creating a new chain that now becomes the longest block and the digitized content is moved to the receiving party.

The disclosed system allows digitized items to be used as intended based on cryptographic proof instead of trust, allowing any two or more willing parties to employ the content as intended without the need to trust each other and without the need for a trusted third party. The purpose includes, but is not limited to, ensuring that digital content is 1) a unique and unaltered original; 2) was not altered after a given timestamp; 3) that alterations made can be followed to a traceable point of origin; 4) that only people with authorized keys can access the document; 5) that the document itself cannot be duplicated; 6) that where duplication is allowed, the integrity of the copy is maintained along with the original; 7) that the document creator was authorized to create the document; or 8) that the document holder was authorized to transfer, alter, or otherwise act on the document.

One of ordinary skill in the art would recognize that a cryptographic system of one or more encrypted private keys, also known as hashtag keys, uses pairs of keys: 1) public keys, which may be disseminated widely, and 2) private keys, which are known only to the owner. Key generation depends on cryptographic algorithms based on mathematical problems to produce one-way functions. Effective security only requires keeping the private key private. The public key can be openly distributed without compromising security.

Inventive concepts now will be described more fully hereinafter with reference to the accompanying drawings, which are intended to be read in conjunction with both this summary, the detailed description and any preferred and/or particular embodiments specifically discussed or otherwise disclosed. Inventive concepts may, however, be embodied in many different forms and should not be construed as limited to the embodiments set forth herein; rather, these embodiments are provided by way of illustration only and so that this disclosure will be thorough, complete, and will fully convey the full scope of the inventive concepts to those skilled in the art.

### BRIEF DESCRIPTION OF THE DRAWINGS

FIG. 1A illustrates the merging of digital content for the computer-implemented system and method for merging digital content.

FIG. 1B illustrates the adding of digital content that is not merged for the computer-implemented system and method for merging digital content.

FIG. 1C illustrates merging content with digital artwork represented by heart as defined herein for the computer-implemented system and method for merging digital content.

FIG. 2 illustrates public and private keys for the computer-implemented system and method for merging digital content.

FIGS. 3A-3C illustrate a neural processing unit and patterns of merging digital content.

FIGS. 4A-4C illustrate unpacking digital content for the computer-implemented system and method for merging digital content.

FIG. 5 illustrates a blockchain system for the computer-implemented system and method for merging digital content.

FIG. 6A illustrates a node and network assembly for the computer-implemented system and method for merging digital content.

FIG. 6B illustrates a computer processor for the computer-implemented system and method for merging digital content.

FIG. 6C illustrates a database for storing information and data.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

Unprotected digital artworks such as still images, animations, drawings, and videos created by one or more persons are, like other digital content, reproducible in a way that does not diminish the quality of the copies from the original. Innumerable copies of a digital artwork indistinguishable from the original artwork can be reproduced from a source of origin and cause the originator to lose control of the digital work. Exclusivity and authenticity, however, are the essence of an artwork and its value. Copying can adversely affect the sale and distribution of digital artwork for the originator, causing the digital artwork to fail to reach its potential either because the digital artwork is easily copied or because security controls make access to the digital artwork too difficult.

Derivative works can be made from one or more previously created digital artworks to form a derivative digital artwork. Such derivative artwork can also be easily copied and may create security concerns if hackers can break through security passwords and access private content such as personal photographs in their original form. The representative inventive concept affords a system and methods that facilitates the production of digital artworks and derivative digital artworks while protecting the authenticity and exclusivity of both the original digital works and the derivative digital works. This improves the ability of a computer to store and represent protected digital works by allowing the computer to display derivative digital works while retaining the security and integrity of the original digital works from which the derivative digital works were derived.

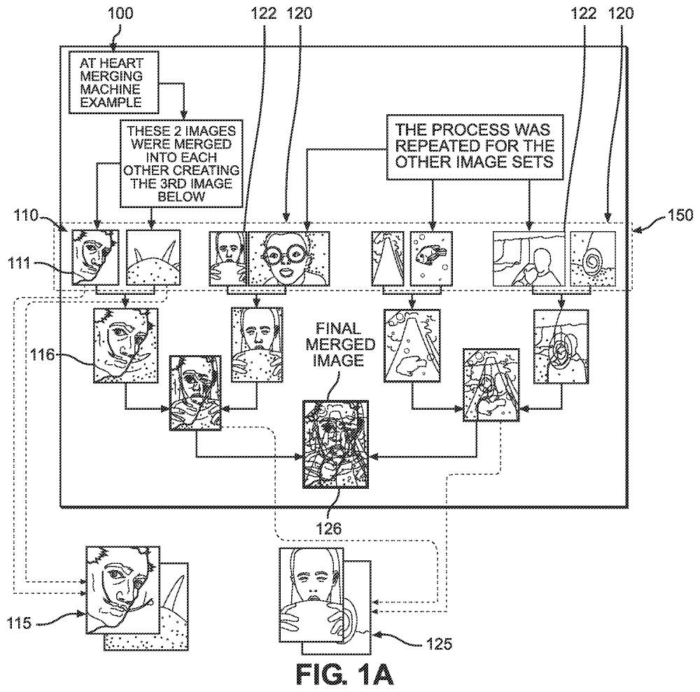

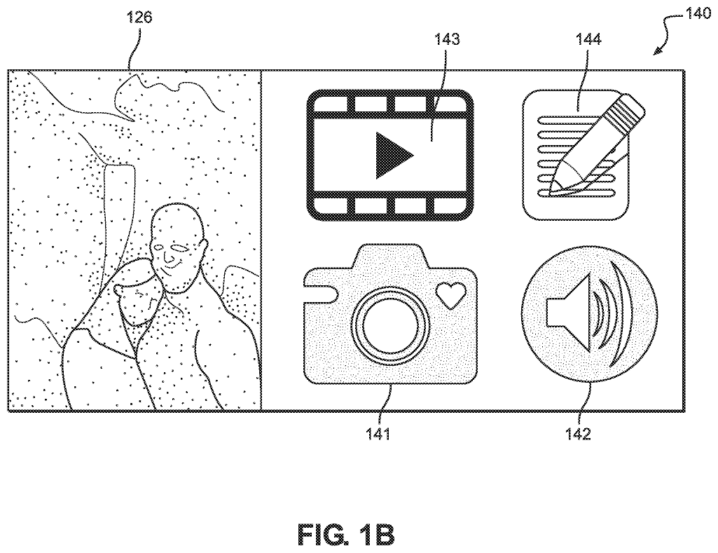

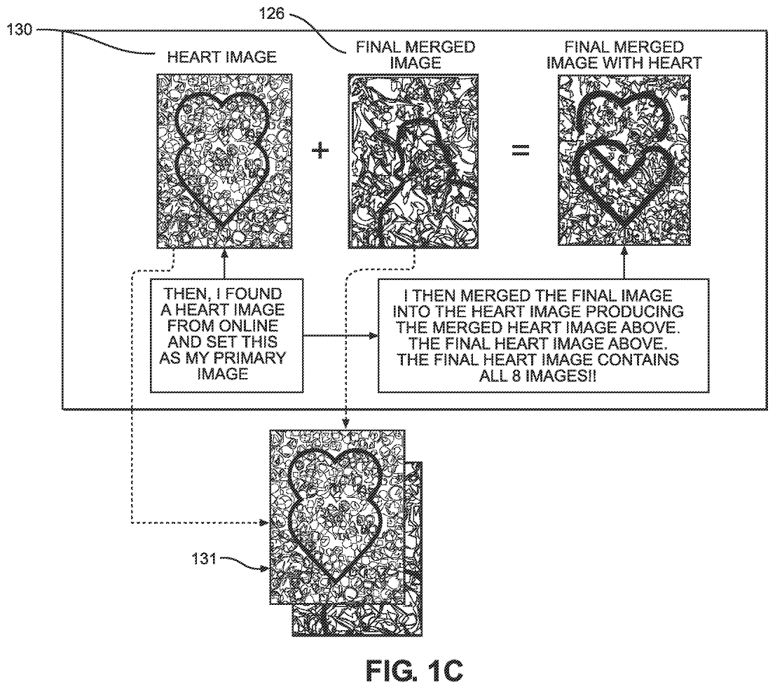

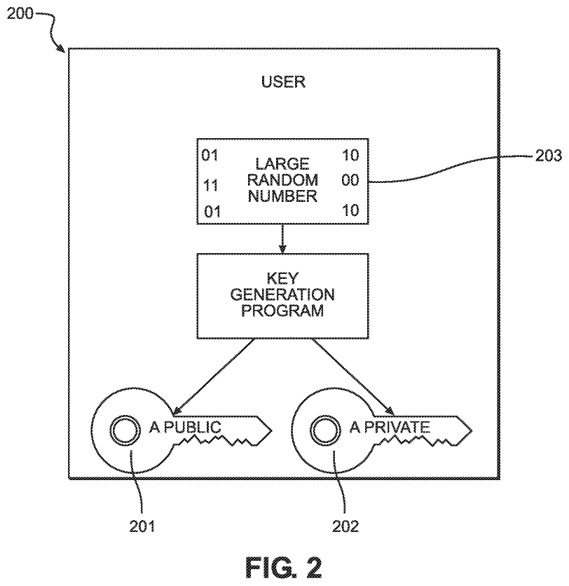

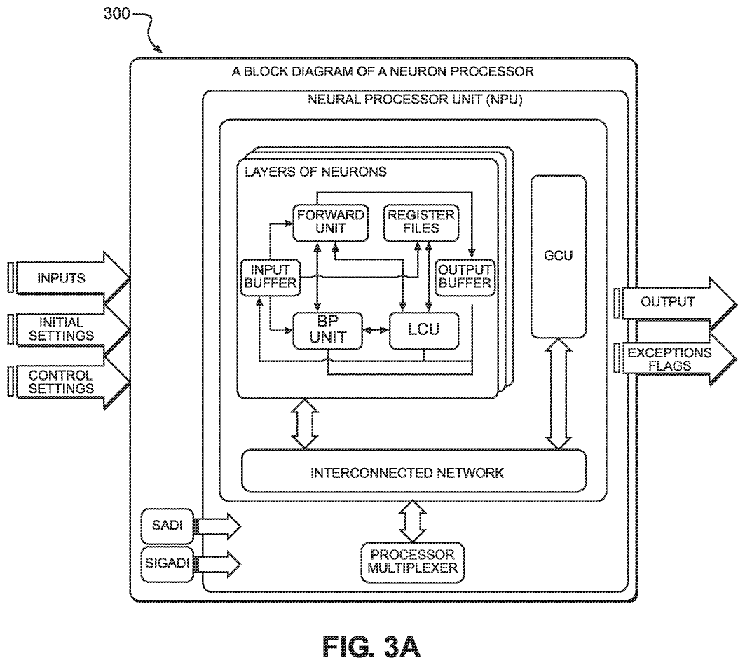

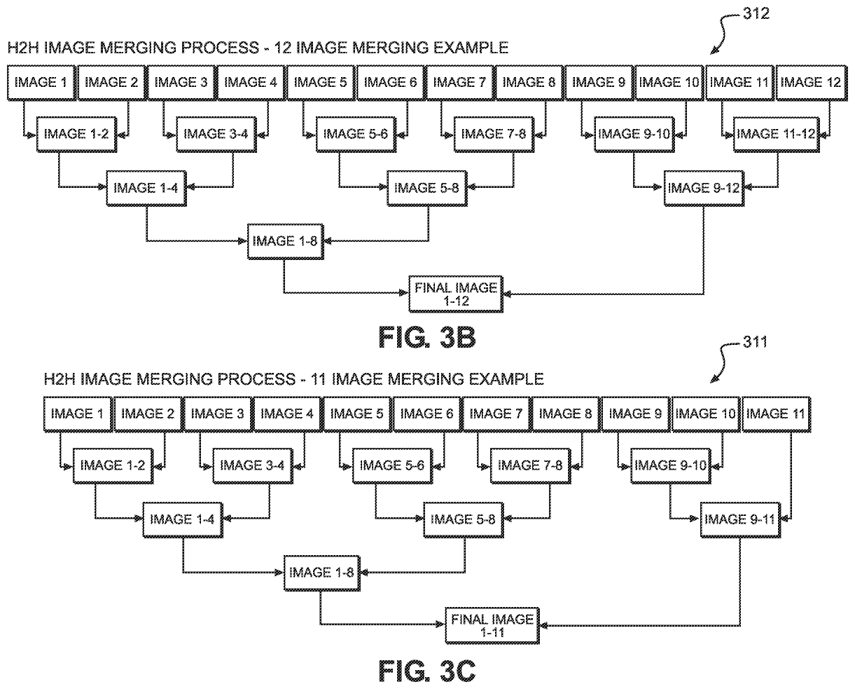

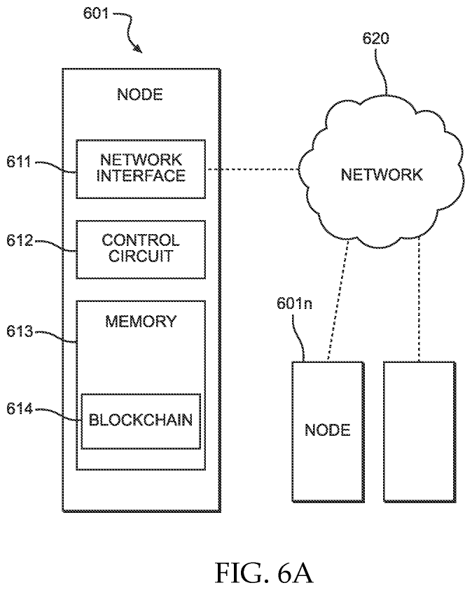

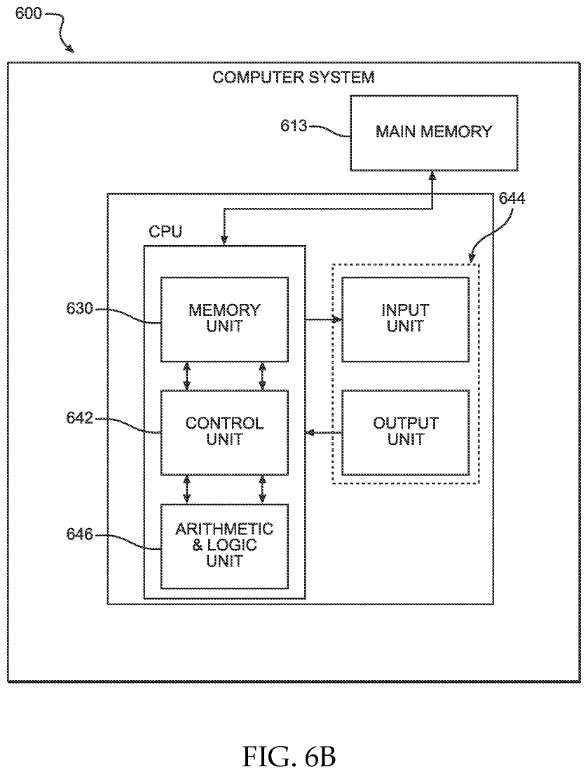

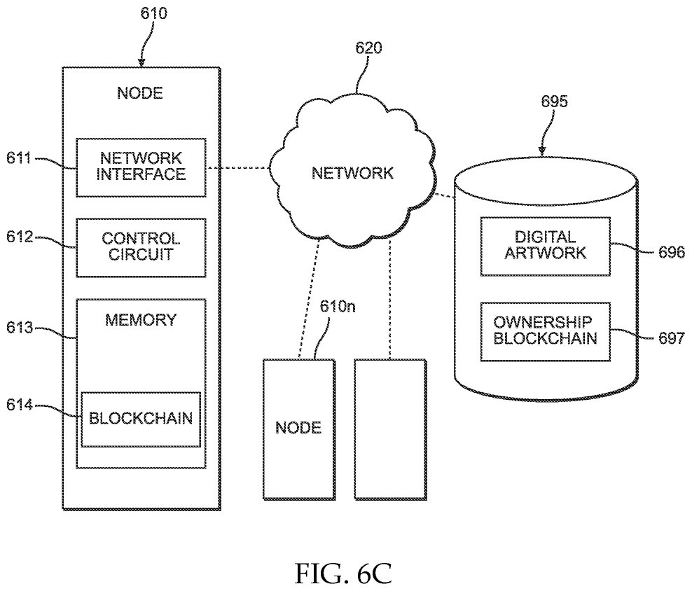

Referring to the figures, FIG. 1A, in this embodiment illustrates merging of digital content for a computer-implemented system and method for merging digital content 100 that involves receiving a first plurality of data 110 from one or more computer assemblies 600, with reference to FIG. 6B, herein, wherein the first plurality of data 110 includes one or more first digital images 111 and receiving at least one second plurality of data 120 from the one or more computer assemblies 600 wherein the second plurality of data 120 includes at least one second digital image 122. The first plurality of data 110 from the one or more computer assemblies 600 is registered, calibrated, and coordinated so the one or more first digital images 111 at least partly overlap. The registered, calibrated, and coordinated first plurality of data 115 is sent to a neural processing unit assembly 300, with reference to FIG. 3, herein, the neural processing unit assembly 300 designed to at least partially blend the first plurality of data 110 so as to include one or more first combined digital images 116. The first plurality of data 110 that includes the one or more first combined digital images 116 from the one or more computer assemblies 600 and the second plurality of data 120 from the one or more computer assemblies 600 is registered, calibrated, and coordinated to create a second registered, calibrated, and coordinated data assembly 125 so the one or more first combined digital images 116 and at least one second digital image 122 at least partly overlap. The at least one second registered, calibrated, and coordinated data assembly 125 is sent to a neural processing unit assembly 300 on at least one computer assembly 600 configured with the neural processing unit assembly 300, the neural processing unit assembly 300 designed to at least partially blend the first plurality of data 110 from the one or more computer assemblies 600 that include the one or more first combined digital images 116 and the second plurality of data 120 from the one or more computer assemblies 600 so as to include one or more second combined digital images 126. The production of the one or more second combined digital images 126 triggers communicating with one or more nodes 601, with reference to FIG. 6A, in a computer network assembly 600 to validate the production of the one or more second combined digital images 126 and assigns, with reference to FIG. 2, herein, one or more encrypted private keys 200 thereto.

FIG. 1A, of this embodiment further illustrates the computer-implemented system and method for storing, securing, and retrieving digital content 100, the first plurality of data 110 from the one or more computer assemblies 600 and the at least one second plurality of data 120 from the one or more computer assemblies 600 is stored both in registered, calibrated, and coordinated and in unregistered, uncalibrated, and uncoordinated form 150. In one embodiment of the computer-implemented system and method for storing, securing, and retrieving digital content 100, the unregistered, uncalibrated, and uncoordinated data 150 is designed to be stored within the at least one second registered, calibrated, and coordinated data assembly 126.

FIG. 1B, of this embodiment illustrates that at least one third plurality of data is received from the one or more computer assemblies 600, with reference to FIG. 6B, herein, associated with a first user wherein the fourth plurality of data 140 includes one or more image 141, audio 142, video 143, or text 144 content assemblies, the third plurality of data designed to be combined with a second registered, calibrated, and coordinated data assembly as exemplified by 126. This fourth plurality of data 140 may be combined or coupled with the first plurality of data 110, the second plurality of data 120, or both the first plurality of data 110 and the second plurality of data 120, but the fourth plurality of data 140 is not registered, calibrated, or coordinated for merged.

FIG. 1C, with reference to FIG. 1A, 6B, and 3 herein, of this embodiment illustrates a third plurality of data 130 from one or more computer assemblies 600 that is registered, calibrated, and coordinated to be a registered, calibrated, and coordinated third plurality of data 131 to at least partly overlap the one or more second combined digital images 126, the registered, calibrated, and coordinated third plurality of data 131 sent to the neural processing unit assembly 300, the neural processing unit assembly 300 designed to at least partially blend the registered, calibrated, and coordinated third plurality of data 131 into the one or more second combined digital images 126. In this exemplary embodiment of the inventive concept, a neural processing unit assembly 300 is a specialized circuit that implements all the necessary control and arithmetic logic necessary to execute machine learning algorithms. One of ordinary skill in the art would recognize that software algorithms able to substantially accomplish neural processing may operate using, with reference to FIG. 6B, one or more CPUs 640.

FIG. 2, illustrates a cryptographic system of one or more encrypted private keys 200 uses pairs of keys: 1) public keys 201, which may be disseminated widely, and 2) private keys 202, which are known only to the owner. Key generation depends on cryptographic algorithms 203 based on mathematical problems to produce one-way functions. Effective security only requires keeping the private key 202 private. The public key 201 can be openly distributed without compromising security.

FIG. 3A to 3C, illustrate an NPU 300 and an illustration of how twelve digital images 312 could be merged. It also illustrates how eleven digital images 311 could be merged. One of ordinary skill in the art would recognize that many image merging patterns could be used. At each stage of image merging, the system will merge one or more pairs of images. The system will receive an even or an odd number of images to merge at each merging stage. Where the system receives an odd number, at least one image will not be merged at that stage. The system will determine which image to merge through algorithms that may be executed on one or more conventional CPUs 640, on one or more NPU assemblies 300, on at least one software system emulating an NPU assembly, or a combination thereof. Determining which images to merge, and which image pairs to merge, may involve arithmetic logic such as selecting by order of image entry or image size, it may involve a random number generator applied to select the images, or it may be an assessment of aesthetics likely to produce a combined image that would be attractive to people in general or to the particular user, to illustrate but not be limited to combining images with complementary colors, images that when merged will follow the rule of thirds, images with complementary geometries, images with balanced or matching complexities, and so on, machine learning applicable to improve the results via selected user criterion. One of ordinary skill in the art would recognize a range of digital merging algorithms that could be applied to the inventive concept to include, but not be limited to, Google Deep Dream employing at least one or more of pixel by pixel analysis, pixel cluster analysis, pixel band analysis, and pixel frequency analysis via a convolutional neural network, where image merging may include at least one or more of Poisson blending, image pyramiding or other pixel removal, band-pass and other filtering, band blending by pixel or frequency, linear blending, gradient domain blending, feathering, cloning, seamless cloning, mosaic block, mosaic blend, mosaic seamless cut, sampling, encoded transparency, and cut and paste—these falling under the general categories of image stitching, blending, and mosaic—and may further include an image discriminator whereby merged images may be stitched, blended, and otherwise arrayed to form into another image such as a heart, and may still further include an image stylizer.

One of ordinary skill in the art would recognize the weighting given to prioritized elements for digital merging algorithms, particularly those oriented on aesthetics likely to produce a combined image that would be attractive to people in general or to the given user wherein images may be identified and classified as to which images to merge and in what way. For example, a blend of images where a selected proportion of one image may be a complementary color to a selected proportion of a second image may be blended as a mosaic wherein the complementary colors may produce aesthetic contrasts. For a second example, a blend of images where the subjects are similar, for example, two portraits, may combine to produce a composite portrait through pyramid blending with some adjustment to the position or magnification of the respective images to create alignment. For a third example, images that may be of similar items but substantially opposite facing may be stitched where the blending happens substantially in one band and the images on either side of the band may remain as substantially unmerged content. Machine learning in each example adapts to identify images and produce desirable results with improved reliability based on the inputted weights. One of ordinary skill in the art would further recognize that merged images could have a pixel count substantially equivalent to any one image before the given merge, or the combination could result in an increase or decrease in the total pixels of the given merged image than the total pixels present in the sum of pixels from the images being merged.

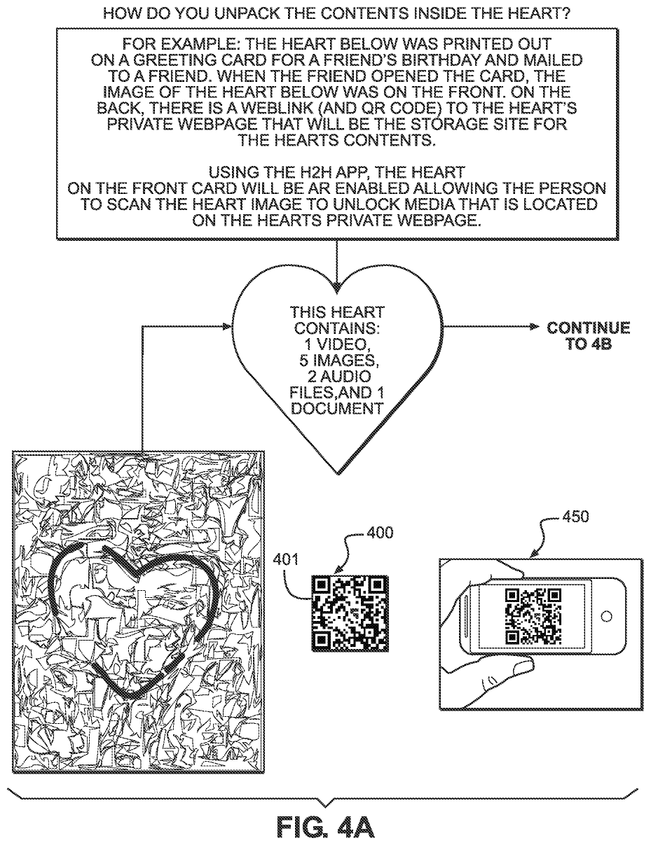

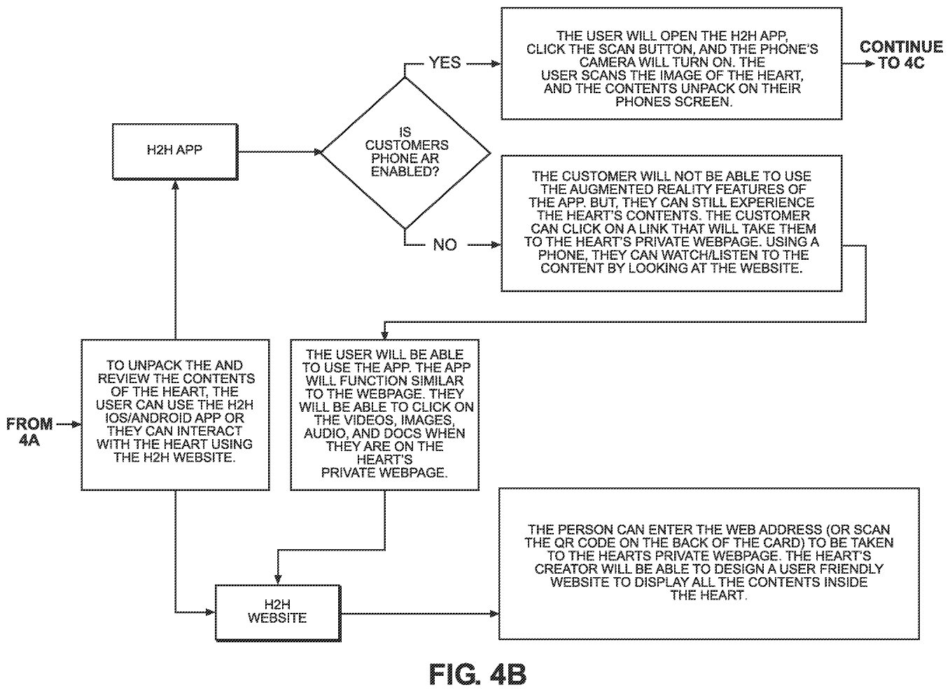

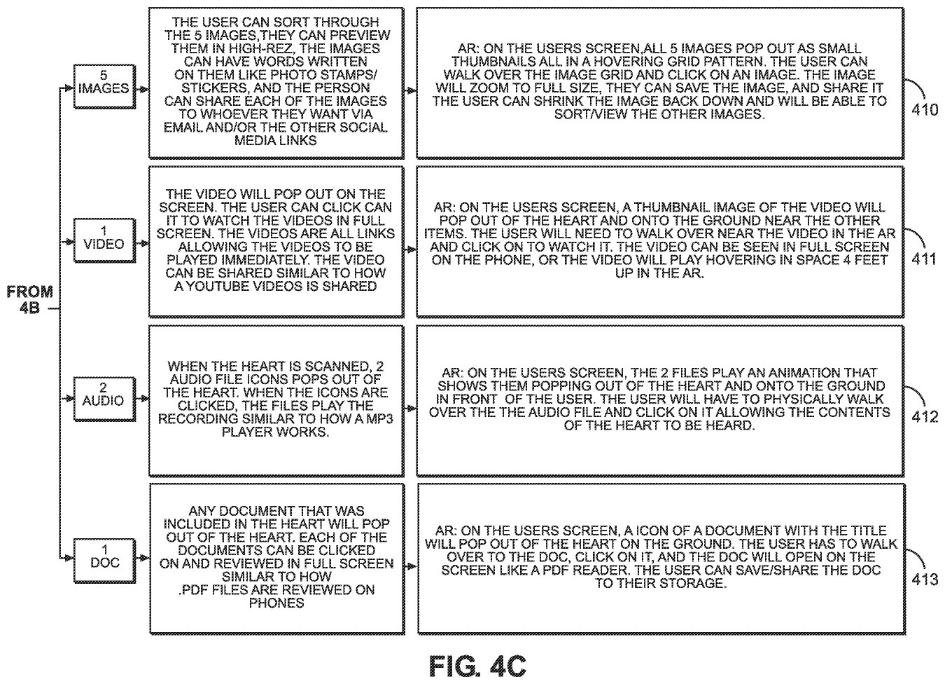

FIG. 4A to 4C of this embodiment illustrate receiving at least one machine-readable code assembly 400 containing coded information 401 corresponding to the first plurality of data 110 from the one or more computer assemblies 600, with reference to FIGS. 1A and 6B, herein, wherein the first plurality of data 110, includes one or more first digital images 111 and corresponding to at least one second plurality of data from the one or more computer assemblies 600 wherein the at least one second plurality of data 120 includes at least one second digital image 121. A user scans the machine-readable code assembly 400 with a scanner assembly 450 in communication with at least one computing system 600 configured to read a machine-readable code processing assembly 400. Processing the machine-readable code assembly 400 to retrieve the coded information 401 therein and processing the coded information 401 therein to retrieve from the first plurality of data 110 and the at least one second plurality of data 120 a data assembly 150 of the first plurality of data 110 and the at least one second plurality of data 120 in an uncombined state. One of ordinary skill in the art would recognize that data in the uncombined state 150 could be viewed or otherwise employed in its original form.

FIG. 4A to 4C of this embodiment further illustrate that the user can sort through images 410, the user can preview the one or more images 410, the one or more images 410 can have words written on them like photo stamps/stickers, and the person can share each of the one or more images 410 through email or other social media links. One or more videos 411 will display on the screen. The user can click on the one or more videos 411 to watch the one or more videos 411 on screen. The one or more videos 411 are links allowing the one or more videos 411 to be played immediately. One or more audio files 412 may be accessible on screen. When the one or more audio files 412 are clicked, the one or more audio files 412 play. One or more document files 413 may display on screen. The one or more document files 413 can be clicked on and viewed on screen. In this embodiment of the computer-implemented system and method for retrieving digital content, with reference to FIG. 1A, herein, the first plurality of data 110 and the at least one second plurality of data 120 in an uncombined state is stored within the one or more second combined digital images 126.

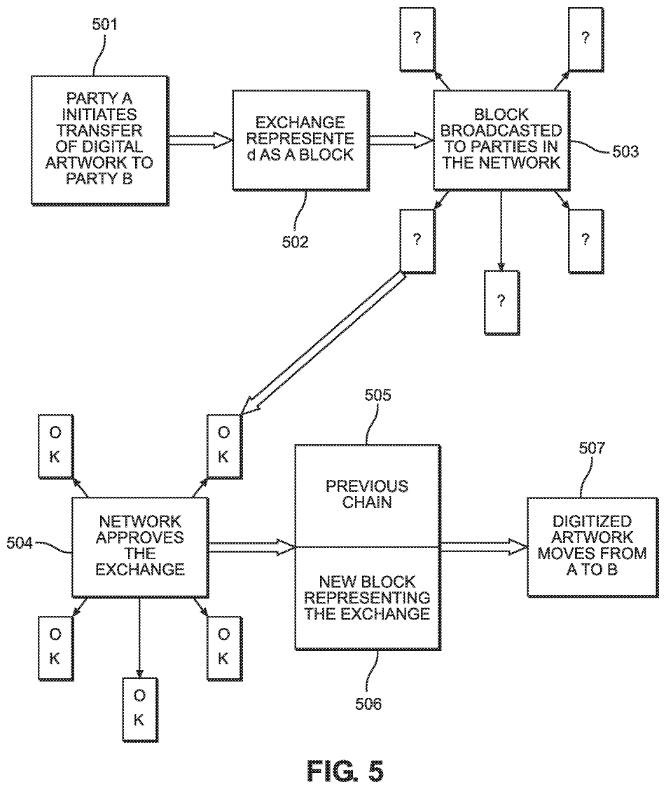

Now referring to FIG. 5, a process diagram, a blockchain update according to some implementations is shown. In step 501, party A initiates the transfer of a digital artwork to party B. In some embodiments, Party A may prove that he has possession of the digital artwork by signing the transaction with a private key that may be verified with a public key in the previous transaction of the digital artwork. In step 502, the exchange initiated in step 501 is represented as a block. In some embodiments, the transaction may be compared with transaction records in the longest chain in the distributed system to verify party A's ownership. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-time, or proof-of-space, may be used in the system. In some embodiments, a block may represent one or more transactions between different parties that are broadcasted to the nodes. In step 503, the block is broadcasted to parties in the network. In step 504, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the digital artwork he or she seeks to transfer). In some embodiments, a block may be approved with consensus of the nodes in the network. After a block is approved, the new block 506 representing the exchange is added to the existing chain 505 comprising blocks that chronologically precede the new block 506. The new block 506 may contain the transaction or transactions and a hash of one or more blocks in the existing chain 505. In some embodiments, each node may then update their copy of the blockchain with the new block and continue to work on extending the chain with additional transactions. In step 507, when the chain is updated with the new block, the digital artwork is moved from party A to party B.

Now referring to FIG. 6A, illustrates a system according to some embodiments. A distributed blockchain system has a plurality of nodes 601 communicating over a network assembly 620. In some embodiments, the nodes 601 may have a distributed blockchain server assembly and/or a distributed timestamp server assembly. Each node 601 in the system has a network interface assembly 611, a control circuit assembly 612, and a memory assembly 613. The control circuit assembly 612 may have at least one processor assembly, at least one microprocessor assembly, and may be configured to execute computer-readable instructions stored on a computer-readable storage memory assembly 613. The computer-readable storage memory assembly may comprise volatile and/or non-volatile memory and have stored upon it a set of one or more computer-readable instructions which, when executed by the control circuit assembly 612, causes the node 601 to update the blockchain 614 stored in the memory assembly 613 based on communications with other nodes 601n over the network assembly 620. In some embodiments, the control circuit assembly 612 may further be configured to extend the blockchain 614 by processing updates to form new blocks for the blockchain 614. Generally, each node may store a version of the blockchain 614, and together, may form a distributed database assembly. In some embodiments, each node 601 may be configured to perform one or more steps described with reference to FIG. 5, herein.

FIG. 6A, further illustrates the network interface assembly 611 may have one or more network devices configured to allow the control circuit assembly to receive and transmit information via the network assembly 620. In some embodiments, the network interface assembly 611 may have one or more of a network adapter, modem, a router, data port, and transceiver assembly. The network assembly 620 may have a communication network assembly configured to allow one or more nodes 601n to exchange data. In some embodiments, the network assembly 620 may have one or more of the Internet, a local area network, a private network, a virtual private network, a home network, a wired network, and a wireless network assembly. In some embodiments, the system does not include a central server assembly and/or a trusted third-party system. Each node in the system may enter and leave the network assembly at any time.

With reference to FIG. 6B, a central processing unit (CPU) 640, also called a central processor or main processor, is the electronic circuitry within a computer 600 that executes instructions that make up a computer program. The CPU 640 performs basic arithmetic, logic, controlling, and input/output (I/O) operations specified by the instructions in the program. An arithmetic & logic unit (ALU) 646 is a combination digital electronic circuit that performs arithmetic and bitwise operations in integer binary numbers. Traditionally, the term CPU 640 refers to a processor, more specifically to its processing unit and control unit (CU) 642, distinguishing these core elements of a computer from external components such as main memory 613 and input output (I/O) circuitry 644. A CPU 640 may also contain memory 630. Memory 630 refers to a component that is used to store information for immediate use in a computer 600.

FIG. 6C, with reference to FIG. 6A, herein, illustrates a one or more databases 695 that may store information/data, as described herein inclusive of digital artworks. For example, they can include one or more digital artworks 696 and ownership blockchain data 697.

While inventive concepts have been described above in terms of specific embodiments, it is to be understood that the inventive concepts are not limited to these disclosed embodiments. Upon reading the teachings of this disclosure, many modifications and other embodiments of the inventive concepts will come to mind of those skilled in the art to which these inventive concepts pertain, and which are intended to be and are covered by both this disclosure and the appended claims. It is indeed intended that the scope of the inventive concepts should be determined by proper interpretation and construction of the appended claims and their legal equivalents, as understood by those of skill in the art relying upon the disclosure in this specification and the attached drawings.

1. A distributed blockchain system for storing, securing, and retrieving digital content, the system comprising:
a plurality of nodes, wherein the plurality of nodes communicates over a network assembly;
a network interface assembly comprising one or more network devices;
a control circuit assembly to receive and transmit information via the network assembly;
a neural processing unit assembly, wherein the neural processing unit assembly processes at least one or more of the merging and unmerging of digital content;
the merged content viewable on one or more user interfaces and the unmerged content viewable from the merged content on the one or more user interfaces by way of at least one or more encrypted private keys; and
a computer-readable storage memory assembly, wherein the computer-readable storage memory assembly comprises a volatile memory storing a set of one or more computer-readable interactions, which when executed by the control circuit assembly cause the plurality of nodes to update the blockchain stored in a memory assembly based on communication with other nodes over the network assembly.

2. The distributed blockchain system for storing, securing, and retrieving digital content of claim 1, wherein the plurality of nodes may have a distributed blockchain server assembly.

3. A distributed blockchain system for storing, securing, and retrieving digital content of claim 1, wherein the system comprises at least one node, further comprising:
a network interface assembly;
a control circuit assembly; and
a memory assembly wherein the node communicates over a network assembly updating the blockchain stored in the memory assembly based on communications with at least a second node.

4. The distributed blockchain system for storing, securing, and retrieving digital content of claim 1, wherein the digital content may be stored in at least one or more of merged and unmerged form.

5. A computer-implemented method for storing, securing, and retrieving digital content comprising:
receiving a first plurality of data from one or more computer assemblies wherein the first plurality of data includes one or more first digital images;
receiving at least one second plurality of data from the one or more computer assemblies wherein the second plurality of data includes at least one second digital image;
registering, calibrating, and coordinating the first plurality of data from the one or more computer assemblies so the one or more first digital images at least partly overlap;
sending the registered, calibrated, and coordinated first plurality of data to a neural processing unit assembly, the neural processing unit assembly adapted to at least partially blend the first plurality of data so as to include one or more first combined digital images;
registering, calibrating, and coordinating the first plurality of data that includes the one or more first combined digital images from the one or more computer assemblies and the second plurality of data from the one or more computer assemblies to create a second registered, calibrated, and coordinated data assembly so the one or more first combined digital images and at least one second digital image at least partly overlap;
sending the at least one second registered, calibrated, and coordinated data assembly to a neural processing unit assembly on at least one computer assembly configured with the neural processing unit assembly, the neural processing unit assembly adapted to at least partially blend the first plurality of data from the one or more computer assemblies that include the one or more first combined images and the second plurality of data from the one or more computer assemblies so as to include one or more second combined digital images; and
the production of the one or more second combined digital images triggering communicating with one or more nodes in a computer network assembly to validate the production of the one or more second combined digital images and assign one or more encrypted private keys thereto.

6. The computer-implemented method for storing, securing, and retrieving digital content of claim 5, wherein a third plurality of data from one or more computer assemblies is registered, calibrated, and coordinated to at least partly overlap the one or more second combined digital images, the registered, calibrated, and coordinated third plurality of data sent to the neural processing unit assembly, the neural processing unit assembly adapted to at least partially blend the registered, calibrated, and coordinated third plurality of data into the one or more second combined digital images.

7. The computer-implemented method for storing, securing, and retrieving digital content of claim 5, wherein the first plurality of data from the one or more computer assemblies and the at least one second plurality of data from the one or more computer assemblies is stored both in registered, calibrated, and coordinated and in unregistered, uncalibrated, and uncoordinated form.

8. The computer-implemented method for storing, securing, and retrieving digital content of claim 6, wherein the first plurality of data from the one or more computer assemblies and the at least one second plurality of data from the one or more computer assemblies is stored both in registered, calibrated, and coordinated and in unregistered, uncalibrated, and uncoordinated form.

9. The computer-implemented method for storing, securing, and retrieving digital content of claim 5, wherein the unregistered, uncalibrated, and uncoordinated data is adapted to be stored within the at least one second registered, calibrated, and coordinated data assembly.

10. The computer-implemented method for storing, securing, and retrieving digital content of claim 6, wherein the unregistered, uncalibrated, and uncoordinated data is adapted to be stored within the at least one second registered, calibrated, and coordinated data assembly.

11. The computer-implemented method for storing, securing, and retrieving digital content of claim 5, wherein at least one fourth plurality of data is received from the one or more computer assemblies associated with a first user wherein the fourth plurality of data includes one or more image, audio, video, or text content assemblies, the fourth plurality of data adapted to be combined with the second registered, calibrated, and coordinated data assembly.

12. The computer-implemented method for storing, securing, and retrieving digital content of claim 6, wherein at least one fourth plurality of data is received from the one or more computer assemblies associated with a first user wherein the fourth plurality of data includes one or more image, audio, video, or text content assemblies, the fourth plurality of data adapted to be combined with the second registered, calibrated, and coordinated data assembly.

13. The computer-implemented method for storing, securing, and retrieving digital content of claim 7, wherein at least one fourth plurality of data is received from the one or more computer assemblies associated with a first user wherein the fourth plurality of data includes one or more image, audio, video, or text content assemblies, the fourth plurality of data adapted to be combined with the second registered, calibrated, and coordinated data assembly.

14. The computer-implemented method for storing, securing, and retrieving digital content of claim 8, wherein at least one fourth plurality of data is received from the one or more computer assemblies associated with a first user wherein the fourth plurality of data includes one or more image, audio, video, or text content assemblies, the fourth plurality of data adapted to be combined with the second registered, calibrated, and coordinated data assembly.

15. A computer-implemented method for retrieving digital content comprising: receiving at least one machine-readable code assembly containing coded information corresponding to a first plurality of data from the one or more computer assemblies wherein the first plurality of data includes one or more first digital images and corresponding to at least one second plurality of data from the one or more computer assemblies wherein the at least one second plurality of data includes at least one second digital image;
scanning with a scanner assembly in communication with at least one computing system configured with a machine-readable code processing assembly;
processing the machine-readable code assembly to retrieve the coded information therein; and
processing the coded information therein to retrieve from the first plurality of data and the at least one second plurality of data a data assembly of the first plurality of data and the at least one second plurality of data in an uncombined state.

16. The computer-implemented method for retrieving digital content of claim 15, wherein the first plurality of data and the at least one second plurality of data in an uncombined state is stored within the one or more second combined digital images.

17. The computer-implemented method for retrieving digital content of claim 15, wherein the first plurality of data and the at least one second plurality of data in an uncombined state is stored on at least one separate file on at least one data storage apparatus.

18. A computer-implemented method for securing digital content comprising:
generating a cryptographically verifiable ledger represented by a sequence of blocks, each block containing one or more ownership records and each subsequent block containing a hash value associated with the previous block, wherein at least one of the blocks contains ownership records associated with ownership of a digital artwork, wherein the at least one of the blocks that contains ownership records associated with ownership of the digital artwork includes restrictions associated with transfers of the digital artwork;
receiving a first request from at least one user terminal device to obtain the digital artwork;
determining whether the restrictions associated with the use of the digital artwork prevents satisfying the request; and
permitting the request for the digital artwork in response to determining the request is authorized.

19. The computer-implemented method for securing digital content of claim 18, wherein the request is to merge the digital artwork with one or more second digital works to create a derived digital artwork.

20. The computer-implemented method for securing digital content of claim 18, wherein the request is to add one or more second digital works to the digital artwork wherein the one or more second digital works is not merged to create a derived digital artwork.
